(19) United States
(12) Patent Application Publication
(10) Pub. No.: US 2016/0290877 A1
(43) Pub. Date: Oct. 6, 2016

(54) SYSTEM AND METHOD FOR MEASURING A TEMPERATURE WITH A GEOPHONE

(71) Applicant: Fairfield Industries Incorporated, d/b/a FairfieldNodal, Sugar Land, TX (US)

(72) Inventors: Timothy M. Betzner, Sugar Land, TX (US); William Guyton, Sugar Land, TX (US)

(73) Assignee: Fairfield Industries Incorporated, d/b/a FairfieldNodal, Sugar Land, TX (US)

(21) Appl. No.: 14/672,519

(22) Filed: Mar. 30, 2015

(51) Int. Cl. G01K 13/00; G01K 7/00; G01V 1/18

(52) U.S. Cl. CPC G01K 13/00; G01V 1/181; G01K 7/00

(57) ABSTRACT

A device and method for measuring the temperature of a battery located within a seismic node is disclosed herein. The device comprising a geophone, having a coil configured to generate an electrical signal in response to a seismic vibration; a circuit configured to measure a value of an electrical property of the coil; a nontransitory storage medium storing program code, configured to convert the electrical property to a temperature.

### FIELD OF THE DISCLOSURE

The present disclosure relates generally to geophones, and in more particular aspects, to systems and methods for determining the temperature of a battery using a geophone.

### BACKGROUND

Geophones are widely used in a variety of applications to measure seismic vibrations. Some applications include reflection seismology, where geophones are deployed to measure seismic vibrations that result from reflected energy waves. These measured seismic vibrations may be used to estimate the properties of the earth surface. This is particularly useful in the oil industry to map petroleum reservoirs within the surface of the earth.

Because geophones are often deployed over a large region, it is advantageous to power each geophone with a battery. These batteries must occasionally be recharged to maintain continued operation. However, these batteries may only be recharged when they are within a certain temperature range. There is currently no efficient way to measure the temperature of a battery within a seismic sensor (node) without installing an additional temperature sensor near the battery—a costly procedure that would require retrofitting scores of seismic nodes already in the field. Accordingly, there exists a need in the art for a simple, efficient way to measure the temperature of a battery located within a seismic node without installing a new temperature sensor.

### SUMMARY

Battery powered seismic nodes require a quick and simple way to measure the temperature of the battery located within a seismic node, without installing a temperature sensor near the battery. Accordingly various embodiments herein are directed to a system and method for measuring the temperature of a seismic node with a geophone located in proximity to the battery. In an exemplary embodiment, an electrical property of a coil located within the geophone is measured and converted to a temperature.

According to an aspect, a device configured to measure a temperature comprises: a geophone, having a coil configured to generate an electrical signal in response to a seismic vibration; and, a circuit configured to measure a value of an electrical property of the coil; a nontransitory storage medium storing program code, configured to convert the electrical property to a temperature measurement.

According to an embodiment, the program code is further configured to determine whether a battery should be charged according to the measured temperature.

According to an embodiment, the program code is further configured to determine the rate to charge a battery according to the measured temperature.

According to an embodiment, the electrical property is one of: resistivity, impedance, conductivity, conductance, resistance, or admittance.

According to an embodiment, the program code is further configured to store the measured temperature on a nontransitory storage medium contained within the seismic node.

According to an embodiment, the device further comprises a transmitter configured to transmit the measured temperature value to a device accessible to a user or to a host device such as, but not limited to a computer, a server, and a charger module.

According to an embodiment, the circuit comprises: a voltage divider having a plurality of resistances, interconnected to the coil; a voltage source, operatively connected to the voltage divider to apply a first voltage; and an electrical measurement device configured to measure a second voltage in the voltage divider.

According to an embodiment, the program code is further configured to determine the electrical property from the first voltage, the second voltage, and the plurality of resistances.

According to an embodiment, the circuit comprises: a current divider having a plurality of resistances, interconnected to the coil; a current source, operatively connected to the current divider to apply a first current; and an electrical measurement device configured to measure the second current in the current divider.

According to an embodiment, the program code is further configured to determine the electrical property from the first current, the second current, and the plurality of resistances.

According to another aspect, a method of measuring the temperature of a geophone, comprises: providing a geophone, having a coil configured to generate an electrical signal in response to a seismic vibration; measuring, with the circuit, an electrical property of the coil; and converting the electrical property to a temperature measurement.

According to an embodiment, the method further comprises the step of determining whether a battery should be charged according to the measured temperature.

According to an embodiment, the method further comprises the step of determining the rate to charge a battery according to the measured temperature.

According to an embodiment, the electrical property is one of: resistivity, impedance, conductivity, conductance, resistance, or admittance.

According to an embodiment, the method further comprises the step of storing the measured temperature value on a nontransitory storage medium contained within the seismic node.

According to an embodiment, the method further comprises the step of transmitting the measured temperature value to a device accessible to a user or to a host device such as, but not limited to a computer, a server, and a charger module.

According to an embodiment, the circuit comprises: a voltage divider having a plurality of resistances, interconnected to the coil; a voltage source, operatively connected to the voltage divider to apply a first voltage; and an electrical measurement device configured to measure a second voltage in the voltage divider.

According to an embodiment, the step of measuring an electrical property comprises determining the electrical property from the first voltage, the second voltage, and the plurality of resistances.

According to an embodiment, the circuit comprises: a current divider having a plurality of resistances, interconnected to the coil; a current source, operatively connected to the current divider to apply a first current; and an electrical measurement device configured to measure the second current in the current divider.

According to an embodiment, the step of measuring an electrical property comprises determining the electrical property from the first current, the second current, and the plurality of resistances.

In accordance with an exemplary embodiment of the present invention, a specialized improved computer system is created—here the devices and/or systems that are specifically structured, configured, connected, and/or programmed to calculate a temperature from an electrical property of a geophone. This calculation allows a temperature of a battery located within a seismic node to be approximated without the need for an additional temperature sensor.

### BRIEF DESCRIPTION OF THE SEVERAL VIEWS OF THE DRAWING(S)

Embodiments of the present invention will be more fully understood and appreciated by reading the following Detailed Description in conjunction with the accompanying drawings, in which:

FIG. 1 shows a schematic of a seismic node according to an embodiment;

FIG. 2 shows a method of measuring the temperature of a seismic node according to an embodiment; and

FIG. 3 shows a schematic of a circuit according to an embodiment.

### DETAILED DESCRIPTION OF NON-LIMITING, EXEMPLARY EMBODIMENTS

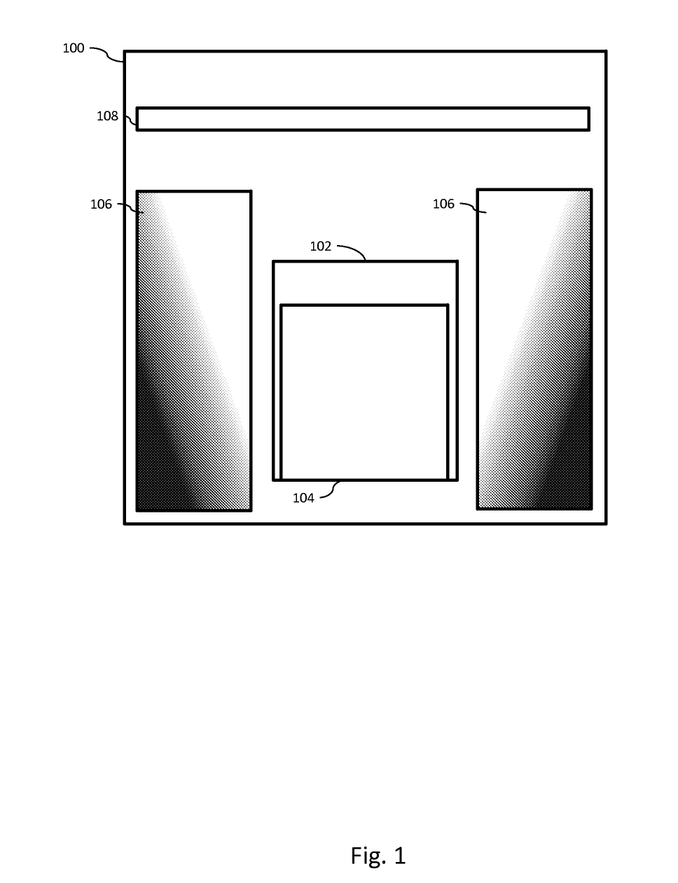

Referring now to the drawings, wherein like reference numerals refer to like parts throughout, there is seen in FIG. 1 a seismic node 100, according to an embodiment. Herein, a seismic node is any device containing a geophone and configured to measure seismic vibrations when in use. Seismic node 100 contains a geophone 102 having a coil 104 configured to generate an electric signal in response to a seismic vibration. Seismic node 100 may also contain a battery 106 for powering the seismic node when it is deployed. In an exemplary embodiment, coil 104 is placed sufficiently near to battery 106 to be affected by the temperature of the battery. As shown, coil 104 may be placed adjacent battery cells 106 (i.e., in the center of or offset from the center), such that the coil 104 is nearest to the warmest portions of the batteries (the warmer portions of battery 106 are displayed in FIG. 1 as a lighter shade than the colder portions). Accordingly, the coil 104 is well placed to measure the temperature of the batteries 106 according to various embodiments disclosed herein. Seismic node 100 may further contain a circuit 108 configured to measure an electrical property of coil 104, and a nontransitory storage medium containing program code configured to convert the electric property to a temperature value. The nontransitory storage medium may be contained within circuit 108 or elsewhere within seismic node 100. The nontransitory storage medium may be further configured to determine whether battery 106 should be charged or to determine the rate at which battery 106 should be charged.

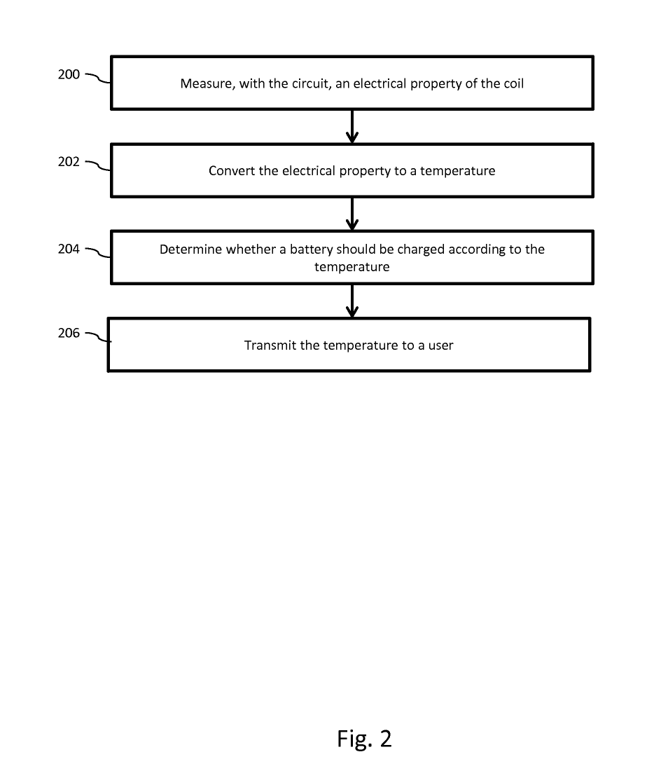

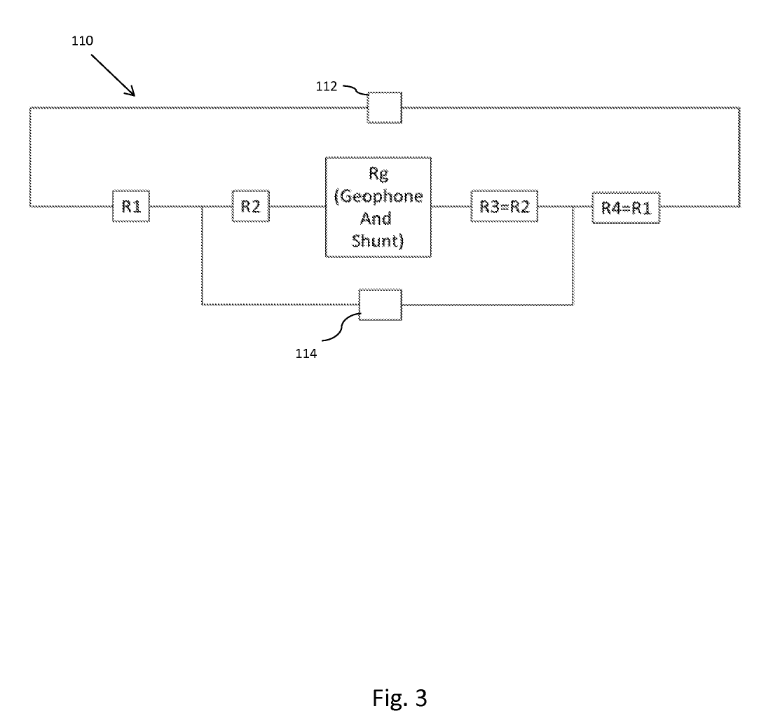

FIG. 2 shows an embodiment of a method for using a seismic node to measure a temperature. In step 200, circuit 108 measures an electrical property of coil 104. In an exemplary embodiment, the measured electrical property may be any of: resistivity, impedance, conductivity, conductance, resistance, or admittance. Although any circuit may be used to measure one of the above-listed electrical properties, in an exemplary embodiment, circuit 108 applies a known voltage or current to coil 104 and measures the resulting current or voltage, respectively. For example, to measure the resistance of coil 104, circuit 100 may comprise a voltage divider, such as voltage divider 110 shown in FIG. 3. Voltage divider 110 comprises a voltage source 112 configured to induce a voltage Vₛ. As shown, voltage source 112 is connected in series with coil 104 and several resistors in the following order: R1, R2, coil 104, R3, and R4. In some cases (as known in the art), the resistance R_{g} may comprise the parallel connection of coil 104 and a shunt resistor. The final resistor R4, is further connected to the negative terminal of Vₛ. In an exemplary embodiment, R3 is equivalent in resistance to R2, and R4 is equivalent in resistance to R1, although other resistances may be used. The voltage drop across R2, coil 104, and R3 may be measured with a voltmeter 114 (or similar device for measuring a voltage) and defined as Vₘ. From the above, we may calculate the resistance of coil 104 to be:

$${R}_{g} = \frac{2 {V}_{m} {R}_{1}}{{V}_{s} - {V}_{m}} - 2 {R}_{2}$$

where R_{g} represents the resistance of coil 104, and the values of R3 and R4 have been substituted for the resistance of R2 and R1, respectively. Here, the step of calculating the resistance from the measured value of Vₘ, according to the above equation, may be performed by program code stored on/in a nontransitory storage medium. In this way, the step of measuring the electrical property of coil 104 may comprise the sub-steps of first measuring a separate property of circuit 108 and then deriving the desired electrical property. One of ordinary skill in the art will readily appreciate that different circuits may be employed to measure the same or different electrical properties of coil 104 as may be advantageous or otherwise preferable. For example, circuit 108 may be implemented with a current source instead of a voltage source, creating a current divider. A current divider embodiment would measure the resulting current through a configuration of resistors, as opposed to the resulting voltage. From the current source, the measured current, and values of resistors comprising the current divider circuit, the electrical property may be determined. As known, different circuits may require different calculations to be performed on the measured value to determine the desired electrical property.

Referring again to FIG. 2, in step 202 the measured electrical property is converted into a temperature value indicative of the temperature of the coil. The method for converting the electrical property into a temperature value will depend upon which electrical property is measured in step 200. Further, for any given electrical property, any number of methods may be used to convert the given electrical property to a temperature value.

Broadly speaking, for any electrical property, this conversion may be achieved through available formulae, empirical data, or a combination thereof. For example, using coil 104 of a given length and diameter and of a known material, such as copper, known formulae may be applied to determine the temperature given the measured resistivity (or other electrical property) of coil 104. Alternatively, each coil may be individually pretested to determine its resistivity for a given temperature or set of temperatures. For example, any given coil 104 may be pretested over a range of temperatures to determine the coil's resistivity for any temperature within the range. As a simpler method, the resistivity may be measured for two or more known temperatures, and the remaining temperatures may be derived or determined from the two known resistances. For example, the resistivity of coil 104 may be measured at 0° C. and again at 10° C., whereupon a line may be drawn between the measured points and extended in either direction to cover a given range of temperatures. As yet another method, a plurality of coils may be pretested, and the measured data averaged. This average value may be used as the data points and applied to each deployed coil as an accurate approximate method of determining the temperature from resistivity. To combine the above methods, a known curve for a given coil material may be calibrated through experimentation. The data points, or ranges and corresponding temperatures may be stored as a lookup table, or as a relation defined by an equation. One of ordinary skill will appreciate that the above methods are merely exemplary and any method known in the art for deriving or determining the temperature of a coil given a measured electrical property may be used.

In step 204, the calculated temperature may be used to determine whether battery 106 is ready to be charged. Battery 106 may only be charged in an acceptable temperature range. Accordingly, the measured temperature may be compared to the acceptable temperature to determine whether the measured temperature is within the range. Furthermore, the rate at which battery 106 may be charged is dependent on the temperature. Therefore, the measured temperature may be used to determine the appropriate rate at which to charge the battery. In addition, because the temperature of a battery changes as it is charged, the temperature may be continuously (or periodically) measured during charging to determine when to cease charging. Finally, if other temperature sensors, such as thermistors are available remote from the geophone 102, such as part of circuit 108, or additional geophone coils in a multi-component seismic node, the distribution of temperature may be estimated according to the difference in temperature measured by each coil or sensor. Thus battery charging can be controlled by accounting for both transient and gradient effects of temperature.

Any of the values measured in steps 200-204 (i.e. electrical property, temperature, etc.) may be stored until the seismic node is pulled for charging, whereupon the temperature may be read to determine whether the seismic node may be charged. The data may be measured upon a command from a user or host, or periodically at a predetermined interval. In an alternate embodiment, seismic node 100 may further comprise a transmitter (not shown) for transmitting data to a remote location, as shown in step 206 of FIG. 2. For example, seismic node 100 may transmit to a user or to a host device (more particularly, to a host device or a device accessible to a user) a time when the seismic node is ready to be charged. Alternatively, a seismic node may transmit the temperature of the battery, or some other measured property of the seismic node 100, including the measured electrical property of coil 104 or any other measurements that may be useful to a user or host. Any data may be transmitted at a predetermined interval or upon a query from a user and/or host. It should be understood that ‘transmit’ means to transfer data either wirelessly and/or by a hard connection such as wire or optical fiber.

As will be appreciated by one skilled in the art, aspects of the present invention may be embodied/implemented as a computer system, method, or computer program product. Accordingly, aspects of the present invention may take the form of an entirely hardware embodiment, an entirely software embodiment, an entirely firmware embodiment, or an embodiment combining software/firmware and hardware aspects that may all generally be referred to herein as a “circuit,” “module,” “system,” or an “engine.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction performance system, apparatus, or device.

The program code may perform entirely on the user's computer, partly on the user's computer, entirely or partly on a seismic node or other device, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowcharts/block diagrams in the Figures illustrate the architecture, functionality, and operation of possible implementations of systems, methods, and computer program products according to various embodiments of the present invention. In this regard, each block in the flowcharts/block diagrams may represent a module, segment, or portion of code, which comprises instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A device configured to measure a temperature comprising:
a geophone having a coil configured to generate an electrical signal in response to a seismic vibration;
a circuit configured to measure a value of an electrical property of the coil; and
a nontransitory storage medium storing program code, configured to convert the electrical property to a temperature measurement.

2. The device of claim 1, wherein the program code is further configured to determine whether a battery should be charged according to the measured temperature.

3. The device of claim 1 wherein the program code is further configured to determine the rate to charge a battery according to the measured temperature.

4. The device of claim 1, wherein the electrical property is one of: resistivity, impedance, conductivity, conductance, resistance, or admittance.

5. The device of claim 1 wherein the program code is further configured to store the measured temperature on a nontransitory storage medium contained with the seismic node.

6. The device of claim 1, further comprising a transmitter configured to transmit the temperature value to a host device or a device accessible to a user.

7. The device of claim 1, wherein the circuit comprises:
a voltage divider having a plurality of resistances, interconnected to the coil;
a voltage source, operatively connected to the voltage divider to apply a first voltage; and
an electrical measurement device configured to measure a second voltage in the voltage divider.

8. The device of claim 7, wherein the program code is further configured to determine the electrical property from the first voltage, the second voltage, and the plurality of resistances.

9. The device of claim 1, wherein the circuit comprises:
a current divider having a plurality of resistances, interconnected to the coil;
a current source, operatively connected to the current divider to apply a first current; and
an electrical measurement device configured to measure the second current in the current divider.

10. The device of claim 9, wherein the program code is further configured to determine the electrical property from the first current, the second current, and the plurality of resistances.

11. The device of claim 1, wherein the program code is further configured to receive a second temperature measurement from a temperature sensor.

12. The device of claim 11, wherein the temperature sensor is a second coil.

13. The device of claim 11, wherein the program code is further configured to determine the rate to charge a battery according to the difference between the first temperature measurement and the second temperature measurement.

14. A method of measuring the temperature of a geophone, comprising:
providing a geophone, having a coil configured to generate an electrical signal in response to a seismic vibration;
measuring, with the circuit, an electrical property of the coil; and
converting the electrical property to a temperature measurement.

15. The method of claim 14, further comprising the step of determining whether a battery should be charged according to the measured temperature.

16. The method of claim 14, further comprising the step of determining the rate to charge a battery according to the measured temperature.

17. The method of claim 14, wherein the electrical property is one of: resistivity, impedance, conductivity, conductance, resistance, or admittance.

18. The method of claim 14, further comprising the step of storing the measured temperature value on a nontransitory storage medium contained within the seismic node.

19. The method of claim 14, further comprising the step of transmitting the measured temperature value to a host device or a device accessible to a user.

20. The method of claim 14, wherein the circuit comprises:
a voltage divider having a plurality of resistances, interconnected to the coil;
a voltage source, operatively connected to the voltage divider to apply a first voltage; and
an electrical measurement device configured to measure a second voltage in the voltage divider.

21. The method of claim 20, wherein the step of measuring an electrical property comprises determining the electrical property from the first voltage, the second voltage, and the plurality of resistances.

22. The method of claim 14, wherein the circuit comprises:
a current divider having a plurality of resistances, interconnected to the coil;
a current source, operatively connected to the current divider to apply a first current; and
an electrical measurement device configured to measure the second current in the current divider.

23. The method of claim 22, wherein the step of measuring an electrical property comprises determining the electrical property from the first current, the second current, and the plurality of resistances.

24. The method of claim 14, further comprising the step of receiving a second temperature measurement from a temperature sensor.

25. The method of claim 24, wherein the temperature sensor is a second coil.

26. The method of claim 24, further comprising the step of determining the rate to charge a battery according to the difference between the first temperature measurement and the second temperature measurement.
